(19) United States
(12) Patent Application Publication
(10) Pub. No.: US 2025/0010645 A1
(43) Pub. Date: Jan. 9, 2025

(54) PRINTER DEVICE

(71) Applicant: Roland DG Corporation, Hamamatsu-shi (JP)

(72) Inventors: Kikuo MATSUBA, Hamamatsu-shi (JP); Kazuhiro IDA, Hamamatsu-shi (JP); Kenji SEKI, Hamamatsu-shi (JP)

(21) Appl. No.: 18/897,201

(22) Filed: Sep. 26, 2024

Related U.S. Application Data
(63) Continuation of application No. PCT/JP2022/016261, filed on Mar. 30, 2022.

(51) Int. Cl. B41J 29/13; B41J 2/165

(52) U.S. Cl. CPC B41J 29/13; B41J 2/16508

(57) ABSTRACT

A printer device includes a carriage that is linearly movable and includes an ink ejector, a cap to prevent ink from drying and movable into contact with the ink ejector, and a shutter assembly to cover the cap when the ink ejector is separated from the cap. The shutter assembly includes a shutter body to open and close an upper portion of the cap and a lever connected to the shutter body and able to contact the carriage.

### CROSS REFERENCE TO RELATED APPLICATIONS

This application is a Continuation Application of PCT Application No. PCT/JP2022/016261 filed on Mar. 30, 2022. The entire contents of this application are hereby incorporated herein by reference.

### BACKGROUND OF THE INVENTION

### 1. Field of the Invention

The present invention relates to printer devices each including a cap that can be brought into close contact with an ink ejector.

### 2. Description of the Related Art

A printer device is equipped with a cap that is brought into close contact with an ink ejector when the printer device in a standby state in which no printing is performed. As such a printer device, the technology described in Japanese Application No. H11-291509 is known.

The printer device disclosed in Japanese Application No. H11-291509 includes an ink ejector which is able to eject ink, a cap which is brought into close contact with the ink ejector to prevent ink from drying out, and a shutter which is able to cover the cap.

By capping the ink ejector in a standby state in which no printing is performed, it is possible to prevent ink clogging caused by ink adhering to the ink ejector. Further, it is possible to prevent dust from adhering to the cap by covering the cap with the shutter during printing.

### SUMMARY OF THE INVENTION

According to the printer device of Japanese Application No. H11-291509, the carriage is displaced by being brought into direct contact with the shutter. Therefore, there is a risk that the load applied to the shutter may increase. There is room for improvement in this regard.

Example embodiments of the present invention provide printer devices with improved protection performance for a shutter.

According to an example embodiment of the present disclosure, a printer device includes a carriage that is linearly movable and includes an ink ejector to eject ink, a cap movable into close contact with the ink ejector to prevent the ink from drying out, and a shutter assembly to cover the cap when the ink ejector is separated from the cap, wherein the shutter assembly includes a shutter body movable from a retraction position retracted from an upper portion of the cap to a cover position covering the upper portion and a lever connected to the shutter body and able to contact the carriage, and when the carriage moves while being in contact with the lever, the lever is displaced and the shutter body is displaced between the retraction position and the cover position.

According to example embodiments of the present disclosure, it is possible to provide printer devices with improved protection performance for a cap during printing.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a perspective view of a printer device according to an example embodiment and FIG. 1B is a plan view of a carriage of the printer device shown in FIG. 1A.

FIG. 2 is a perspective view of a carriage, a cap, and a shutter assembly of the printer device shown in FIGS. 1A and 1B.

FIG. 3 is a plan view of the cap and the shutter assembly shown in FIG. 2.

FIG. 4 is a perspective view of a first shutter body shown in FIG. 2.

FIG. 5 is a side view of a switching mechanism shown in FIG. 2.

FIG. 6A is a perspective view illustrating a lever located outside an orbit and FIG. 6B is a plan view illustrating the lever located outside the orbit.

FIG. 7 is a diagram illustrating the operation of the cap and the shutter assembly shown in FIG. 3.

FIG. 8 is a diagram illustrating the operation of a shutter biasing structure shown in FIG. 3.

FIG. 9A is a diagram illustrating the operation of the lever at a fully open position when moving toward a fully closed position, FIG. 9B is a diagram illustrating the operation of the lever when reaching the fully closed position, and FIG. 9C is a diagram illustrating the operation of the lever when reaching the fully open position.

### DETAILED DESCRIPTION OF THE EXAMPLE EMBODIMENTS

Example embodiments of the present invention will be described below based on the accompanying drawings. In the following description, left and right indicate the left and right when viewed from the perspective of the printer, and front and rear indicate the front and rear when viewed from the perspective of the paper feed direction by the printer. In the figures, Fr indicates front, Rr indicates rear, Le indicates left, Ri indicates right, Up indicates up, and Dn indicates down.

### EXAMPLE EMBODIMENTS

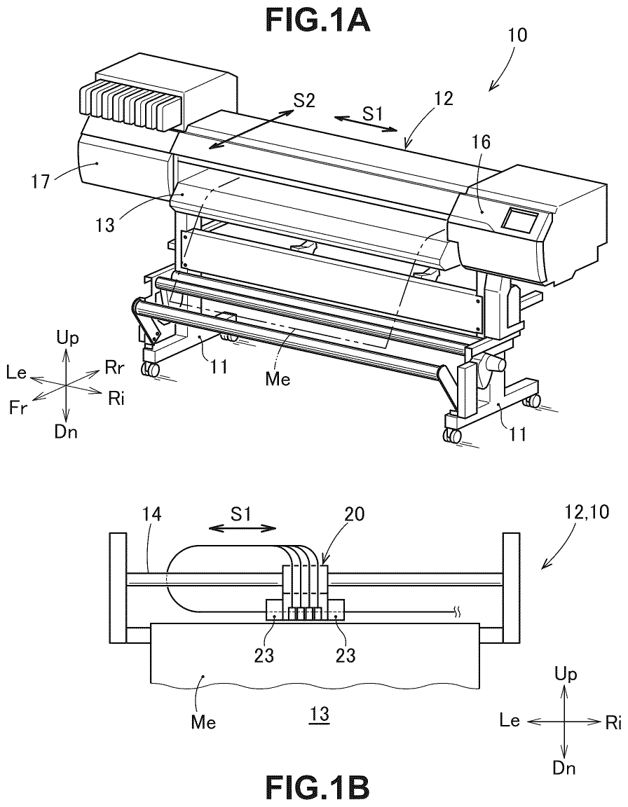

Referring to FIG. 1A, a printer device 10 includes left and right legs 11 and 11 on which casters are provided and a printing unit 12 that is supported by these legs 11 and 11 and can perform printing.

Furthermore, the printer device 10 does not need to have casters on the legs 11 and 11 and may include only the printing unit 12.

Referring to FIG. 1B, the printing unit 12 includes a table portion 13 which is located in the center and on which a printing object Me such as paper can be placed, a rail 14 which extends in the left and right direction above the table portion 13, a carriage 20 that is movable on the rail 14 (see the arrow S1) and can eject ink, and lids 16 and 17 which are provided at the left and right ends and can swing in the up and down direction.

The rail 14 extends linearly to a portion covered by the lids 16 and 17, and the carriage 20 is also movable linearly from above the table portion 13 to a portion covered by the lids 16 and 17.

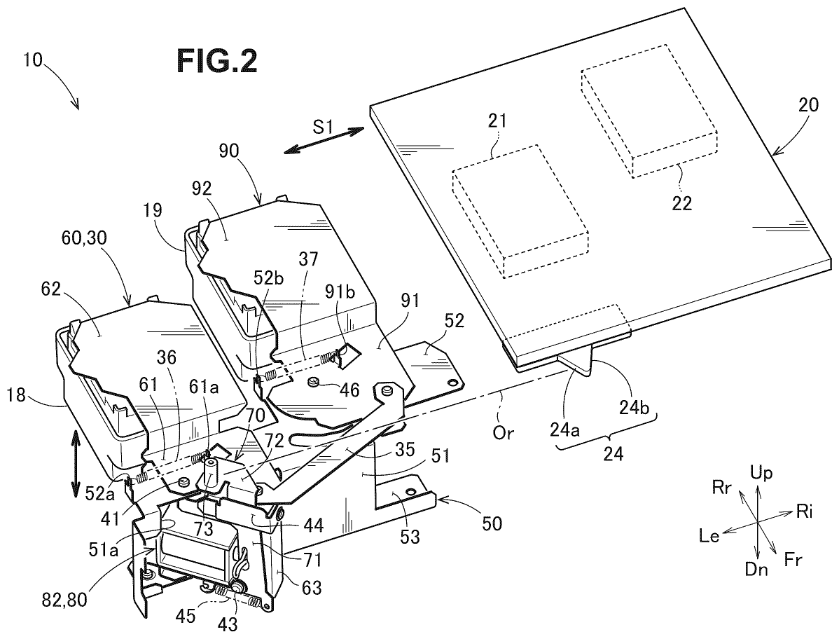

Referring to FIGS. 1B and 2, the carriage 20 includes, for example, two ink ejectors 21 and 22 capable of ejecting ultraviolet curable ink onto the printing object Me and a lamp 23 that irradiates the ejected ink with ultraviolet rays.

For example, when the printing object Me is paper, the paper is fed from the rear to the front on the upper surface of the table portion 13 (see the arrow S2 in FIG. 1A). The carriage 20 ejects ultraviolet curable ink toward the paper while moving in the left and right direction (see the arrow S1). The ejected ink is irradiated with ultraviolet ray from the UV lamp 23 and the ink is cured. Accordingly, a predetermined pattern or the like can be printed on the paper.

Furthermore, the printing object Me may be something other than paper, and ink other than ultraviolet curable ink may be used.

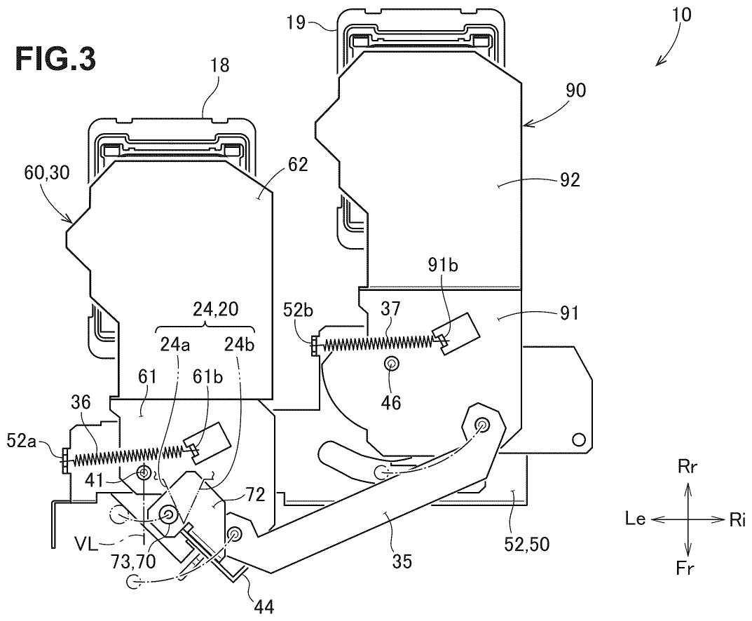

Referring to FIGS. 2 and 3, FIGS. 2 and 3 show a portion of the printer device 10 in a print mode. In a portion covered by a lid 16 (see FIG. 1A) of the printer device 10, caps 18 and 19 that can be brought into close contact with the ink ejectors 21 and 22 in a standby state and a shutter assembly 30 that can cover the caps 18 and 19 when the ink ejectors 21 and 22 are separated from the caps 18 and 19 are provided. In the print mode shown in the drawing, the caps 18 and 19 are separated from the ink ejectors 21 and 22 and are covered by the shutter assembly 30.

The carriage 20 may include, for example, two ink ejectors 21 and 22 and a contact body 24 that can come into contact with the shutter assembly 30.

The contact body 24 includes two contact surface portions 24a and 24b which can come into contact with the shutter assembly 30. The two contact surface portions 24a and 24b preferably are substantially V-shaped and are both inclined at the same angle with respect to the traveling direction of the carriage 20. Two contact surface portions 24a and 24b include a first contact surface portion 24a which comes into contact with the shutter assembly 30 when opening the shutter assembly 30 and a second contact surface portion 24b which comes into contact with the shutter assembly 30 when closing the shutter assembly 30.

Two caps 18 and 19 are displaceable in the up and down direction. In a standby state in which no printing is performed, the caps 18 and 19 are brought into close contact with the ink ejector 22 to prevent the ink from drying out. Hereinafter, the left cap 18 may be referred to as the first cap 18, and the right cap 19 may be referred to as the second cap 19.

The shutter assembly 30 mainly includes a support 50, a first shutter body 60 (shutter body 60) which is supported by the support 50 to be rotatable in the horizontal direction and can open and close the upper portion of the first cap 18, a lever 70 that is connected to the first shutter body 60 and is able to contact the contact body 24 of the carriage 20, a switching mechanism 80 which is connected to the lever 70 and can switch the position of the lever 70 to be on or outside the orbit Or of the carriage 20, a second shutter body 90 (shutter body 90) which is supported by the support 50 to be rotatable in the horizontal direction and can open and close the upper portion of the second cap 19, a connection arm portion 35 which connects the first shutter body 60 and the second shutter body 90, a first shutter biasing structure 36 which extends from the support 50 to the first shutter body 60 and biases the first shutter body 60 in a closing direction, and a second shutter biasing structure 37 which extends from the support 50 to the second shutter body 90 and biases the second shutter body 90 in a closing direction.

The support 50 is a substantially U-shaped structure that opens rearward and is a single plate-shaped structure that is elongated in the left and right direction. The support 50 includes a vertical wall portion 51 which extends in the up and down direction, an upper wall portion 52 which extends rearward from the upper end of the vertical wall portion 51, and a lower wall portion 53 which extends rearward from the lower end of the vertical wall portion 51.

The vertical wall portion 51 is provided with a through hole 51a through which the switching mechanism 80 passes.

The upper wall portion 52 is provided with a first locking portion 52a that is raised to lock one end of the first shutter biasing structure 36 and a second locking portion 52b that is raised to lock one end of the second shutter biasing structure 37.

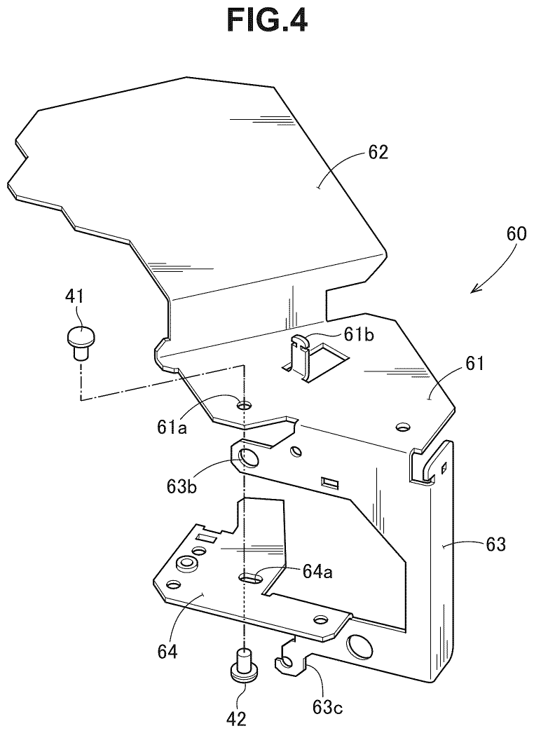

Referring to FIGS. 2 and 4, the first shutter body 60 can be made of a single metal plate. The first shutter body 60 includes a first support plate portion 61 (support plate portion 61) which is supported above the upper wall portion 52 through a first pin portion 41 including a pin, a first shutter portion 62 (shutter portion 62) rotatable together with the first support plate portion 61 and can cover the first cap 18, a lever support plate portion 63 which extends substantially vertically downward from the first support plate portion 61 and supports the lever 70 to be swingable, and a second support plate portion 64 which extends from the lower end of the lever support plate portion 63 in substantially parallel to the first support plate portion 61 and is supported below the lower wall portion 53 through a second pin portion 42 including a pin.

Particularly, referring to FIG. 4, the first shutter body 60 is rotatable in a substantially horizontal direction around the first pin portion 41 and the second pin portion 42 which are arranged on the same axis. Hereinafter, the first pin portion 41 may be referred to as the first rotating shaft portion 41, and the second pin portion 42 may be referred to as the second rotating shaft portion 42.

The first support plate portion 61 is provided with a pin through hole 61a through which the first pin portion 41 passes and a first other end locking portion 61b which is cut and raised to lock the first shutter biasing structure 36.

The first shutter portion 62 extends upward and horizontally from the first support plate portion 61 in a substantially L-shape.

Referring to FIG. 2, the lever support plate portion 63 is provided with a through hole 63a which is opened to attach a lever support pin portion 43 as a pin to rotatably support the lever 70, a stay attachment hole 63b which is opened to attach a stay 44 to prevent the lever 70 from falling over while allowing the lever 70 to swing, and one return spring end locking portion 63c which is a spring to bias the lever 70 in the return direction and can lock one end of the lever return spring 45.

The second support plate portion 64 is provided with a pin through hole 64a through which the second pin portion 42 passes.

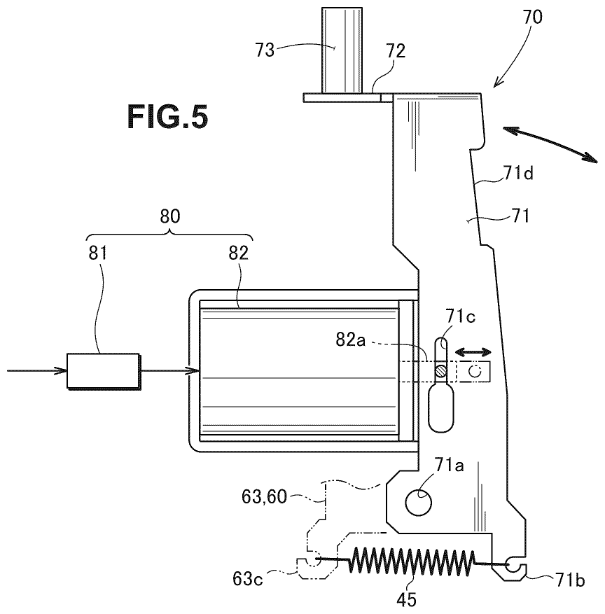

Referring to FIG. 5, the lever 70 includes a lever arm portion 71 which is supported by the lever support plate portion 63 to be swingable, a pin support portion 72 which is bent horizontally from the upper end of the lever arm portion 71, and a contact pin portion 73 which is a columnar pin extending upward from the pin support portion 72 and can come into contact with the contact body 24 (see FIG. 2).

The lever arm portion 71 is provided with a through hole 71a through which the lever support pin portion 43 (see FIG. 2) passes, the other return spring end locking portion 71b which can lock the other end of the lever return spring 45, a switching mechanism connection hole 71c which is opened to connect the switching mechanism 80, and a substantially U-shaped recessed portion 71d that can come into contact with the stay 44 (see FIG. 2) when the lever arm portion 71 is tilted down.

The switching mechanism 80 includes a controller 81 that is configured or programmed to send an electrical signal to switch the position of the lever 70 and a solenoid 82 which allows a solenoid pin 82a to protrude and retract based on the electrical signal from the controller 81 and switches the position of the lever 70.

The solenoid 82 is placed on and supported by the second support plate portion 64 (see FIG. 4) and is connected to the lever 70 through the solenoid pin 82a. The solenoid 82 is rotatable together with the first shutter body 60 (see FIG. 4) and the lever 70.

In the state shown in FIGS. 2 and 5, the lever 70 is located at a position that can come into contact with the contact body 24. That is, the lever 70 is located on the orbit Or of the contact body 24.

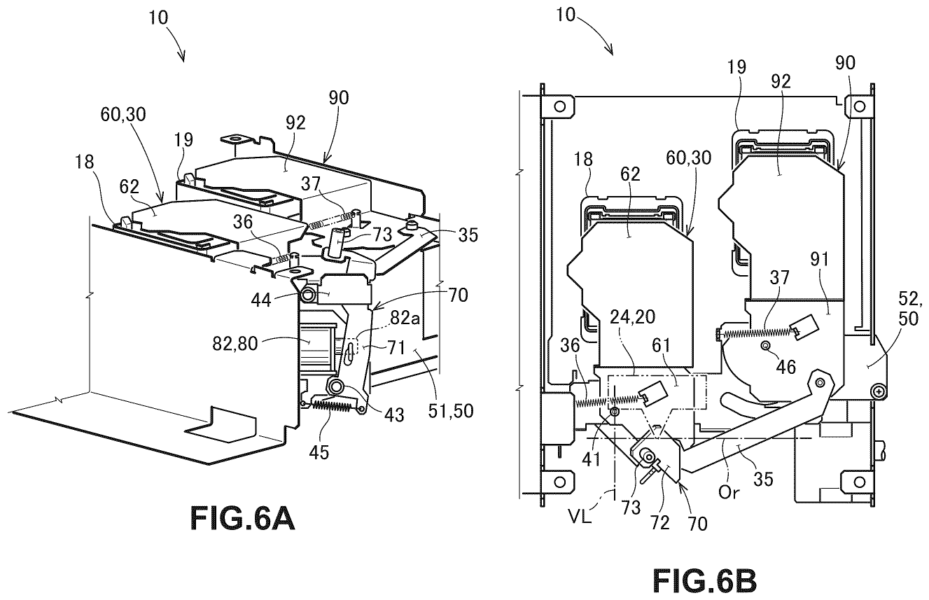

Referring to FIGS. 6A and 6B, the lever 70 is located outside the orbit Or of the contact body 24. When the solenoid pin 82a protrudes (moves forward) from the state shown in FIG. 5, the lever 70 is pressed by the solenoid pin 82a, and rotates to fall about the lever support pin portion 43. Accordingly, the contact pin portion 73 is displaced to the outside of the orbit Or of the contact body 24. That is, when the contact pin portion 73 is located outside the orbit Or of the contact body 24, the contact body 24 cannot come into contact with the lever 70.

When the solenoid pin 82a retracts (moves rearward), the lever 70 is pulled by the solenoid pin 82a, and rotates around the lever support pin portion 43 to stand up. Accordingly, the contact pin portion 73 is displaced onto the orbit Or of the contact body 24.

Referring to FIG. 2, when the contact pin portion 73 is located inside the orbit Or of the contact body 24, the contact body 24 can come into contact with the lever 70.

The second shutter body 90 can be made of a single metal plate. The second shutter body 90 includes a support plate portion 91 which is supported above the upper wall portion 52 through a third pin portion 46 as a pin and a second shutter portion 92 rotatable together with the support plate portion 91 and can cover the second cap 19.

The second shutter body 90 is connected to the lever 70 through the connection arm portion 35. The second shutter body 90 is rotatable in a substantially horizontal direction around the third pin portion 46. Hereinafter, the third pin portion 46 may also be referred to as the first rotating shaft portion 46 like the first pin portion 41.

The support plate portion 91 is provided with a second other end locking portion 91b which is cut and raised to lock the second shutter biasing structure 37. Further, although not shown in the drawings, the support plate portion 91 is also provided with a through hole through which the third pin portion 46 passes.

The second shutter portion 92 extends upward and horizontally from the support plate portion 91 in a substantially L-shape.

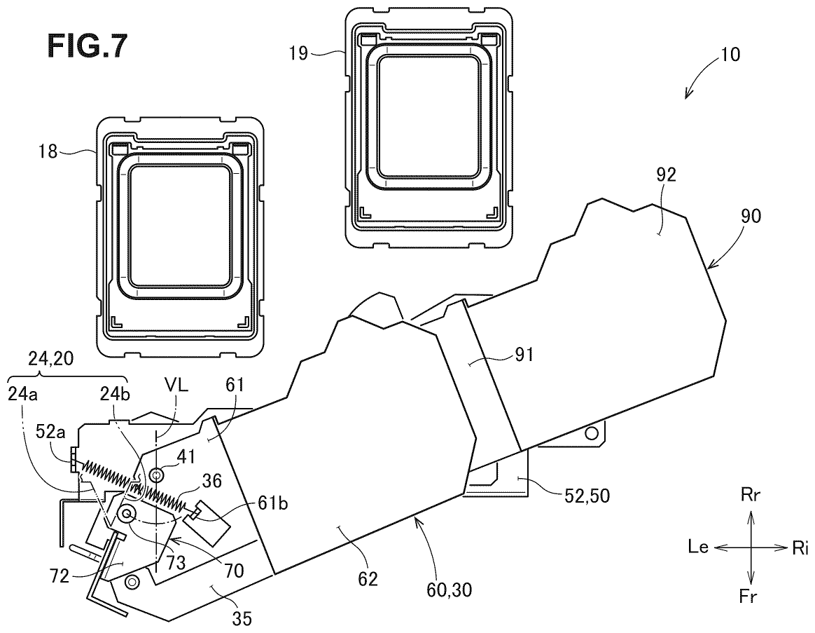

Referring to FIGS. 3 and 7, the first shutter biasing structure 36 includes a compression spring, and is configured to bias the first shutter body 60 in the opening direction when the first shutter body 60 is in a fully open state (the state shown in FIG. 3) and bias the first shutter body 60 in the closing direction when the first shutter body 60 is in a fully closed state (the state shown in FIG. 7). Hereinafter, this will be described in detail.

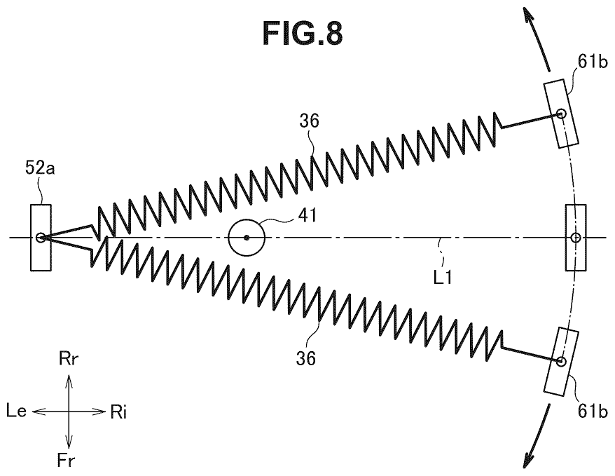

As shown in FIGS. 3 and 8, when the first shutter body 60 covers the first cap 18, the first other end locking portion 61b is located behind the line Li connecting the first locking portion 52a and the first pin portion 41 (on one side of the line Li connecting the first locking portion 52a and the first pin portion 41). In this case, when the biasing direction of the first shutter biasing structure 36 is divided into a tangential direction of the rotational orbit of the first shutter body 60 and a normal direction to this tangential direction, the force in the tangential direction is directed in the counterclockwise direction. That is, the first shutter biasing structure 36 biases the first shutter body 60 in the closing direction (counterclockwise direction).

On the other hand, as shown in FIGS. 7 and 8, when the first shutter body 60 opens the upper portion of the first cap 18, the first other end locking portion 61b is located on the front side of the line Li connecting the first locking portion 52a and the first pin portion 41 (on the other side of the line Li connecting the first locking portion 52a and the first pin portion 41). In this case, when the biasing direction of the first shutter biasing structure 36 is divided into a tangential direction of the rotational orbit of the first shutter body 60 and a normal direction to this tangential direction, the force in the tangential direction is directed in the clockwise direction. That is, the first shutter biasing structure 36 biases the first shutter body 60 in the opening direction (clockwise direction).

Referring to FIGS. 3 and 7, the second shutter biasing structure 37 is similar to the first shutter biasing structure 36. That is, the second shutter biasing structure 37 is composed of a compression spring and is configured to bias the second shutter body 90 in the compressing direction. When the second shutter body 90 covers the second cap 19, the second shutter biasing structure 37 biases the second shutter body 90 in the closing direction (counterclockwise direction). On the other hand, when the second shutter body 90 opens the upper portion of the second cap 19, the second shutter biasing structure 37 biases the second shutter body 90 in the opening direction (clockwise direction).

Furthermore, it is also possible to use a magnet, a plunger, a suction cup, and the like instead of the first shutter biasing structure 36 and/or the second shutter biasing structure 37 so long as the first shutter body 60 and/or the second shutter body 90 can be stably disposed and can be removed from that position when a force of a certain level or more is applied to rotate the shutter body 90.

The operation of the printer device 10 described above will be described.

Referring to FIGS. 6A and 6B, when the carriage 20 is performing printing, the lever 70 is retracted to a position where the contact body 24 cannot come into contact with the lever. In the print mode, it is not necessary to open the upper portion of the caps 18 and 19. Therefore, the shutter assembly 30 can be prevented from operating by retracting the lever 70 with the caps 18 and 19 closed.

Referring to FIG. 2, after printing is completed, the caps 18 and 19 are brought into close contact with the ink ejectors 21 and 22 to prevent the ink in the ink ejector 21 and 22 from drying out. In order to cap the ink ejectors 21 and 22, the shutter assembly 30 is operated to open the upper portion of the caps 18 and 19 and move the ink ejectors 21 and 22 to the upper portion of the caps 18 and 19. Next, the caps 18 and 19 are raised until the ink ejectors 21 and 22 are capped.

As described above, the lever 70 is retracted from the orbit Or of the contact body 24 during printing. Referring to FIG. 5, when printing is completed and the carriage 20 moves to the right of the shutter assembly 30, the controller 81 is configured or programmed to control the solenoid 82 so that the solenoid pin 82a moves rearward. When the solenoid pin 82a moves rearward, the lever 70 rotates around the contact pin portion 73 to stand up. Accordingly, the contact pin portion 73 returns onto the orbit Or of the contact body 24.

Referring to FIG. 3, next, when the carriage 20 is moved to the left, the first contact surface portion 24a comes into contact with the contact pin portion 73. When the carriage 20 further moves leftward, the contact pin portion 73 rotates around the first pin portion 41. At this time, the first shutter body 60 supporting the lever 70 also rotates around the first pin portion 41. Further, the second shutter body 90 connected to the lever 70 through the connection arm portion 35 rotates around the third pin portion 46.

When the contact body 24 presses the contact pin portion 73, the shutter portions 62 and 92 rotate, and the upper portions of the caps 18 and 19 are opened. The contact body 24 rotates the contact pin portion 73 to a fully open position and stops at the fully open position.

Referring to FIGS. 2 and 7, it is preferable that the ink ejectors 21 and 22 are located above the caps 18 and 19 when the carriage 20 moves to a position (retracted position) where the shutter bodies 60 and 90 are fully open. In this case, it is possible to cap the ink ejectors 21 and 22 by raising the caps 18 and 19. That is, there is no need to adjust the positions of the ink ejectors 21 and 22.

Referring to FIG. 3, if a line perpendicular to the orbit Or of the carriage 20 (see FIG. 2) and passing through the first pin portion 41 is defined as a vertical line VL, the lever 70 passes through the vertical line VL when the shutter bodies 60 and 90 rotate from a fully open position to a fully closed position. The reason for this setting will be described below.

Referring to FIG. 2, the operation when the ink ejectors 21 and 22 are switched from a capped state to a print mode will be described. In order to switch the print mode, it is necessary to cover the ink ejectors 21 and 22 by the shutter bodies 60 and 90 after the caps 18 and 19 are lowered and separated from the ink ejectors 21 and 22.

Referring to FIGS. 5 and 6, the controller 81 controls the solenoid 82 so that the solenoid pin 82a protrudes. When the solenoid pin 82a moves forward, the lever 70 rotates to fall, and the contact pin portion 73 comes off the orbit Or of the contact body 24 (carriage 20). Next, the contact body 24 is moved to the left of the contact pin portion 73.

When the contact body 24 moves to the left of the shutter assembly 30, the controller 81 controls the solenoid 82 so that the solenoid pin 82a moves rearward. When the solenoid pin 82a moves rearward, the lever 70 rotates around the lever support pin portion 43 (through hole 71a). Accordingly, the contact pin portion 73 returns onto the orbit Or of the contact body 24.

Referring to FIG. 7, next, when the carriage 20 is moved to the right, the second contact surface portion 24b comes into contact with the contact pin portion 73. When the carriage 20 further moves rightward, the contact pin portion 73 rotates around the first pin portion 41. The lever 70 including the contact pin portion 73 and the first shutter body 60 supporting the lever 70 also rotate around the first pin portion 41. Further, the second shutter body 90 connected to the lever 70 through the connection arm portion 35 rotates around the third pin portion 46 (see FIG. 2).

The contact body 24 presses the contact pin portion 73 so that the shutter portions 62 and 92 rotate and the upper portions of the caps 18 and 19 are closed. The contact body 24 rotates the contact pin portion 73 to a fully closed position (cover position) and stops at the fully closed position.

Referring to FIG. 5, next, the switching mechanism 80 retracts the lever 70 to the outside of the orbit of the carriage 20 and transitions to the print mode.

The printer device 10 described above will be summarized.

Referring to FIG. 2, the printer device 10 includes the carriage 20 which is provided to be movable linearly and equipped with the ink ejectors 21 and 22 capable of ejecting ink, the caps 18 and 19 which can be brought into close contact with the ink ejectors 21 and 22 and prevent the ink from drying out by being in close contact with the ink ejectors 21 and 22, and the shutter assembly 30 which can cover the caps 18 and 19 when the ink ejectors 21 and 22 are separated from the caps 18 and 19.

The shutter assembly 30 includes the shutter bodies 60 and 90 which are displaceable from the retraction position retracted from the upper portions of the caps 18 and 19 and the cover position covering the upper portions and the lever 70 that is connected to the shutter bodies 60 and 90 and provided to be able to contact the carriage 20, and when the carriage 20 moves while being in contact with the lever 70, the lever 70 is displaced and the shutter bodies 60 and 90 are displaced between the retraction position and the cover position.

In a print mode in which printing is performed, the caps 18 and 19 can be covered by the shutter bodies 60 and 90. By covering the shutter bodies 60 and 90, the caps 18 and 19 can be protected. Thus, it is possible to provide the printer device 10 with improved protection performance for the caps 18 and 19 during printing.

Further, since the shutter bodies 60 and 90 are displaced through the lever 70, the load applied to the shutter bodies 60 and 90 can be reduced compared to when the carriage 20 is brought into direct contact with the shutter bodies 60 and 90. That is, it is possible to provide the printer device 10 with improved protection performance for the shutter.

A plurality of the shutter bodies 60 and 90 are provided and are connected to each other through the connection arm portion 35. A single carriage can open and close the plurality of shutter bodies 60 and 90. Further, since the plurality of shutter bodies 60 and 90 are connected through the connection arm portion 35, the printer device 10 can be made compact.

Referring to FIGS. 6A and 6B, the shutter assembly 30 further includes the switching mechanism 80 capable of switching the position of the lever 70 to be on or outside the orbit Or of the carriage 20. When it is not necessary to open and close the shutter body, the lever 70 can be located outside the orbit Or of the carriage 20. While ensuring the freedom of movement of the carriage 20, high protection performance of the cap can also be ensured.

Referring to FIG. 5, the switching mechanism 80 includes the controller 81 which sends an electrical signal to switch the position of the lever 70 and the solenoid 82 which allows the solenoid pin 82a to protrude and retract based on the electrical signal from the controller 81 and switch the position of the lever 70. It is preferable because the position of the lever 70 can be switched by a simple or compact configuration.

Referring to FIGS. 6A and 6B, the controller 81 is configured or programmed to control the solenoid 82 so that the lever 70 is retracted to the outside of the orbit of the carriage 20 in a print mode in which printing is possible. During printing, the shutter bodies 60 and 90 remain closed and do not need to be opened. By retracting the lever 70 in the print mode, the shutter bodies 60 and 90 can be prevented from opening, and the protection performance of the caps 18 and 19 can be improved.

Referring to FIGS. 3 and 4, the lever 70 rotates around the first pin portion 41 (first rotating shaft portion 41) as the carriage 20 is displaced in a contact state, and the first shutter body 60 (shutter body 60) is rotatable around the first pin portion 41 and the second pin portion 42 (second rotating shaft portion 42) provided on the axis of the first pin portion 41. By rotating around two rotating shaft portions 41 and 42, the first shutter body 60 can be rotated more stably than in the case where there is only one rotating shaft.

Referring to FIGS. 4 and 5, the solenoid 82 is provided between the first pin portion 41 and the second pin portion 42. By arranging the two rotating shafts 41 and 42 at an appropriate distance from each other, the first shutter body 60 can be rotated more stably. Further, since the rotating shaft portions 41 and 42 are appropriately separated from each other and the solenoid 82 is disposed in the empty portion, a space can be saved.

Referring to FIG. 3, if a line perpendicular to the orbit of the carriage 20 and passing through the first pin portion 41 is defined as the vertical line VL, the lever 70 passes through the vertical line VL when the shutter bodies 60 and 90 rotate from a fully open position to a fully closed position.

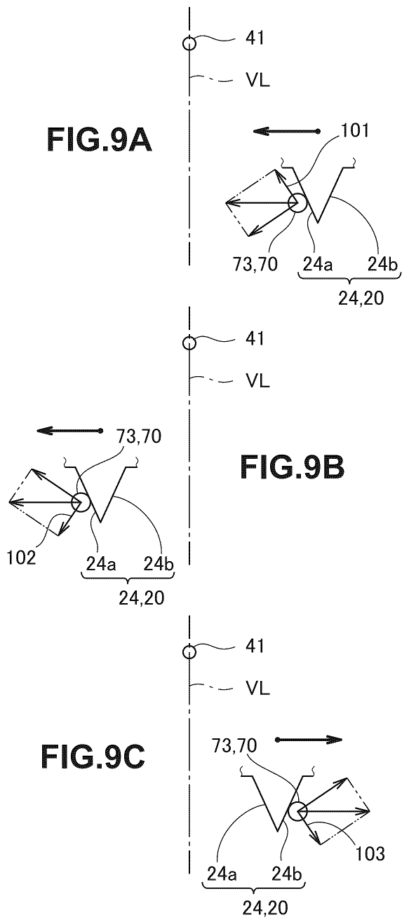

Referring to FIG. 9A, the first pin portion 41, the contact pin portion 73 (lever 70), and the contact body 24 (carriage 20) are in a fully closed state. When the contact pin portion 73 is pressed from the fully closed state, in the loads applied to the contact pin portion 73, the load in the normal direction indicated by the arrow 101 is applied toward the first pin portion 41. That is, the load is applied toward the rotating shaft. In this case, the contact pin portion 73 can be moved more smoothly without releasing the load from the contact body 24.

Referring to FIG. 9B, the first pin portion 41, the contact pin portion 73 (lever 70), and the contact body 24 (carriage 20) are in a fully open state. When the contact pin portion 73 is moved from the fully closed state to the fully open state, the contact pin portion 73 moves to the fully open position beyond the vertical line VL. When the contact pin portion 73 is pressed to the fully open state, in the loads applied to the contact pin portion 73, the load in the normal direction indicated by the arrow 102 is applied in a direction away from the first pin portion 41.

It is assumed that a further load is applied to the contact pin portion 73 from the fully open state. In this case, the load in the normal direction is applied in a direction away from the first pin portion 41. That is, a portion of the load can be released, and the load applied to the lever 70 or the carriage 20 can be reduced.

Referring to FIG. 9C, the first pin portion 41, the contact pin portion 73 (lever 70), and the contact body 24 (carriage 20) are in a fully closed state. When the contact pin portion 73 is pressed from the fully open state to the fully closed state, in the loads applied to the contact pin portion 73, the load in the normal direction indicated by the arrow 103 is applied in a direction away from the first pin portion 41.

It is assumed that a further load is applied to the contact pin portion 73 from the fully open state. In this case, the load in the normal direction is applied in a direction away from the first pin portion 41. That is, a portion of the load can be released, and the load applied to the lever 70 or the carriage 20 can be reduced.

As described above, the load applied in the normal direction changes between the direction toward the rotation axis and the direction away from the rotation axis on either side of the vertical line VL. Further, the load also changes when the direction of the load received from the carriage 20 is reversed.

Referring to FIG. 3, by setting the lever 70 to pass through the vertical line VL when the shutter bodies 60 and 90 rotate from the fully open position to the fully closed position, it is possible to reduce the load applied to the lever 70 and the carriage 20 when the lever 70 is pressed excessively in both the fully open and closed states.

Referring to FIGS. 3 and 8, the shutter assembly 30 includes the shutter biasing structures 36 and 37 that bias the shutter bodies 60 and 90 in the fully opening and closing direction. Each of the shutter bodies 60 and 90 is biased in the fully opening and closing direction by each of the shutter biasing structures 36 and 37. It is preferable because the shutter bodies 60 and 90 can be biased in both directions using a small number of parts.

Although example embodiments of the present invention have been described by taking an example of the printer device that uses ultraviolet curable ink, the present invention is not limited to the printer device that uses ultraviolet curable ink.

The caps of example embodiments of the present invention are suitable for printer devices that use ultraviolet curable ink.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A printer device comprising:
a carriage that is linearly movable and includes an ink ejector to eject ink;
a cap movable into close contact with the ink ejector to prevent the ink from drying out; and
a shutter assembly to cover the cap when the ink ejector is separated from the cap; wherein
the shutter assembly includes a shutter body movable from a retraction position retracted from an upper portion of the cap to a cover position covering the upper portion and a lever connected to the shutter body and able to contact the carriage, and when the carriage moves while being in contact with the lever, the lever is displaced and the shutter body is displaced between the retraction position and the cover position.

2. The printer device according to claim 1, wherein a plurality of the shutter bodies are provided and are connected through a connection arm portion.

3. The printer device according to claim 1, wherein the shutter assembly further includes a switching mechanism capable of switching a position of the lever to be on or outside an orbit of the carriage.

4. The printer device according to claim 3, wherein the switching mechanism includes a controller configured or programmed to send an electrical signal to switch the position of the lever and a solenoid to allow a solenoid pin to protrude and retract based on the electrical signal from the controller and switches the position of the lever.

5. The printer device according to claim 4, wherein the controller is configured or programmed to control the solenoid so that the lever is retracted to the outside of the orbit of the carriage in a print mode in which printing is possible.

6. The printer device according to claim 1, wherein
the lever is rotatable around a first rotating shaft portion as the carriage is displaced in a contact state; and
the shutter body is rotatable around the first rotating shaft portion and a second rotating shaft portion provided on an axis of the first rotating shaft portion.

7. The printer device according to claim 4, wherein
the lever is rotatable around a first rotating shaft portion as the carriage is displaced in a contact state;
the shutter body is rotatable around the first rotating shaft portion and a second rotating shaft portion provided on an axis of the first rotating shaft portion; and
the solenoid is between the first rotating shaft portion and the second rotating shaft portion.

8. The printer device according to claim 1, wherein
the lever is rotatable around a first rotating shaft portion as the carriage is displaced in a contact state; and
if a line perpendicular to an orbit of the carriage and passing through the first rotating shaft portion is defined as a vertical line, the lever passes through the vertical line when the shutter body rotates from a fully open position to a fully closed position.

9. The printer device according to claim 1, wherein the shutter assembly includes a shutter biasing structure to bias the shutter body in a fully opening and closing direction.
